(19) United States
(12) Patent Application Publication
(10) Pub. No.: US 2026/0052230 A1
(43) Pub. Date: Feb. 19, 2026

(54) Electronic Devices with Displays Having Non-Uniform Scaling

(71) Applicant: Apple Inc., Cupertino, CA (US)

(72) Inventors: Emma Hawk, Santa Clara, CA (US); Yang Li, San Jose, CA (US); Sheng Zhang, Saratoga, CA (US); Sikandar Yusufoddin Mashayak, San Jose, CA (US); Shaobo Guan, San Carlos, CA (US)

(21) Appl. No.: 19/049,892

(22) Filed: Feb. 10, 2025

Related U.S. Application Data
(60) Provisional application No. 63/683,959, filed on Aug. 16, 2024.

(51) Int. Cl. H04N 13/351; H04N 13/139; H04N 13/361; H04N 13/383; H04N 13/398

(52) U.S. Cl. CPC H04N 13/351; H04N 13/139; H04N 13/383; H04N 13/361; H04N 13/398

(57) ABSTRACT

An electronic device may have an inner display that displays images for a user and an outer display that informs nearby people of the status of the user and inner display. For example, the outer display may display an image of a face and/or an abstract layer depending on an operating mode of the inner display. The outer display may be a three-dimensional display that displays a three-dimensional image based on a two-dimensional image. The two-dimensional image may be scaled based on predetermined attributes of content in the two-dimensional image with predetermined, non-uniform scaling and/or weighted with predetermined, non-uniform weighting based on one or more known/predetermined areas of interest. The predetermined attributes may be located using heuristics, tracking, and/or machine learning. Areas of interest with high complexity may be scaled to be larger than or weighted to be more defined than areas of lower complexity.

This application claims the benefit of U.S. provisional patent application No. 63/683,959, filed Aug. 16, 2024, which is hereby incorporated by reference herein in its entirety.

### FIELD

This relates generally to electronic devices, including electronic devices with input-output components.

### BACKGROUND

Electronic devices sometimes include optical components. For example, a wearable electronic device such as a head-mounted device may include a display for displaying an image.

### SUMMARY

An aspect of the disclosure provides an electronic device. The electronic device may include a housing, at least one camera coupled to the housing configured to capture an image, at least one inward-facing display coupled to the housing, and an outward-facing display coupled to the housing that is configured to display the image with a first region having a first scaling and a second region having a second scaling that is different from the first scaling based on one or more predetermined areas of interest in the image.

An aspect of the disclosure provides a method of operating a head-mounted device with a display. The method may include generating an image of content with a camera, scaling a first region of the image with a first predetermined scaling and a second region of the image with a second predetermined scaling that is different from the first scaling based on predetermined attributes of the content in the image, and displaying the image with the first and second regions on the display.

An aspect of the disclosure provides a method of operating a head-mounted device with an inward-facing display and an outward-facing three-dimensional display. The method may include generating a two-dimensional image comprising a first region with a first weighting and a second region with a second weighting that is different from the first weighting based on one or more predetermined areas of interest using a camera, and displaying the two-dimensional image on the outward-facing three-dimensional display.

### BRIEF DESCRIPTION OF THE DRAWINGS

FIG. 1 is a top view of an illustrative electronic device such as a head-mounted device in accordance with some embodiments.

FIG. 2 is a front view of an illustrative electronic device with a front-facing display, an ambient light sensor, and cameras in accordance with some embodiments.

FIG. 3 is a front view of an illustrative electronic device with a front-facing display displaying content such as a face in accordance with some embodiments.

FIG. 4 is a side view of an illustrative lenticular display that provides images to a viewer in accordance with some embodiments.

FIG. 5 is a top view of an illustrative lenticular lens film showing the elongated shape of the lenticular lenses in accordance with some embodiments.

FIGS. 6A-6C are perspective views of illustrative three-dimensional content that may be displayed by a three-dimensional display in accordance with some embodiments.

FIG. 7 is a schematic diagram of an illustrative electronic device with display pipeline circuitry in accordance with some embodiments.

FIG. 8 is a front view of an illustrative image with non-uniform scaling that may be displayed on a front-facing display in accordance with some embodiments.

FIG. 9 is a front view of an illustrative image with multiple known areas of interest that may be scaled with non-uniform scaling and/or weighted non-uniformly in accordance with some embodiments.

FIG. 10 is a flowchart of illustrative steps that may be used to scale an image non-uniformly in accordance with some embodiments.

FIG. 11 is a flowchart of illustrative steps that may be used to weight portions of an image non-uniformly when the image is captured in accordance with some embodiments.

### DETAILED DESCRIPTION

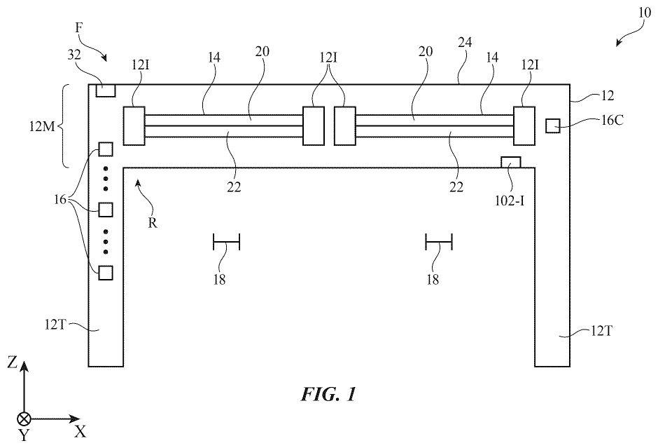

A top view of an illustrative head-mounted device is shown in FIG. 1. As shown in FIG. 1, head-mounted devices such as electronic device 10 may have head-mounted support structures such as housing 12. Housing 12 may include portion (e.g., support structures 12T) to allow device 10 to be worn on a user's head. A main housing portion (e.g., support structure 12M) and associated internal housing portion (e.g., internal support structures 12I) may support the display, lenses, and other optical components (e.g., structures 12I may serve as lens support structures).

Front face F of housing 12 may face outwardly away from a user's head. Rear face R of housing 12 may face the user. During operation, a user's eyes may be placed in eye boxes 18. When the user's eyes are located in eye boxes 18, the user may view content being displayed by one or more displays 14 through associated lenses 22. Each display 14 faces inwardly toward eye boxes 18 and may therefore sometimes be referred to as a rear-facing display, an inner display, an inwardly facing display, a display that is not publicly viewable, or a private display. Front face F of device 10 faces away from eye boxes 18 and faces away from lenses 22.

In some configurations, optical components such as display(s) 14 and lenses 22 are configured to display computer-generated content that is overlaid over real-world images (e.g., a user may view the real world through the optical components). In other configurations, which are sometimes described herein as an example, real-world light is blocked (e.g., by an opaque housing wall at front face F of housing 12 and/or other portions of device 10).

In addition to inwardly facing optical components such as inner display(s) 14 and associated lenses 22 that allow a user with eyes in eye boxes 18 to view images, device 10 may have one or more displays and/or other light-emitting components (e.g., status indicator lights, illuminated button icons, etc.) that are located on exterior surfaces of device 10. Device 10 may, for example, have one or more external displays (sometimes referred to as outwardly facing displays or publicly viewable displays) such as display 24 on front face F. Display 24 may present images that are viewable to people in the vicinity of the user while the user is wearing and while the user is using device 10 to view images on display 14. Display 24 may also be used to display images on the exterior of device 10 that are viewable by the user when device 10 is not being worn (e.g., when device 10 is resting in the user's hand or on a tabletop and is not on a user's head). Display 24 may be a touch sensitive display and/or may be a force sensitive display (e.g., display 24 or part of display 24 may overlap a finger sensor) or, if desired, display 24 may be insensitive to touch and force input. There may be one or more outwardly facing displays such as display 24 in device 10. Haptic output components may be overlapped by one or more of these outwardly facing displays or may be mounted elsewhere in housing 12 (e.g., to provide haptic output when a user supplies finger input such as touch input and/or force input to a portion of a display).

The support structures of device 10 may include adjustable components. For example, support structures 12T and 12M of housing 12 may include adjustable straps or other structures that may be adjusted to accommodate different head sizes. Support structures 12I may include motor-driven adjustable lens mounts, manually adjustable lens mounts, and other adjustable optical component support structures. Structures 12I may be adjusted by a user to adjust the locations of eye boxes 18 to accommodate different user interpupillary distances. For example, in a first configuration, structures 12I may place lenses and other optical components associated respectively with the user's left and right eyes in close proximity to each other so that eye boxes 18 are separated from each other by a first distance and, in a second configuration, structures 12I may be adjusted to place the lenses and other optical components associated with eye boxes 18 in a position in which eye boxes are separated from each other by a second distance that is larger than this distance.

In addition to optical components such as displays 14 and 24, device 10 may contain other electrical components 16. The electrical components of device 10 such as the displays and other electrical components 16 may include integrated circuits, discrete components, printed circuits, and other electrical circuitry. For example, these components may include control circuitry 16C and input-output devices.

Control circuitry 16C of device 10 may include storage and processing circuitry for controlling the operation of device 10. Control circuitry 16C may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 16C may be based on one or more microprocessors, microcontrollers, digital signal processors, baseband processors, power management units, audio chips, graphics processing units, application specific integrated circuits, and other integrated circuits. Software code may be stored on storage in control circuitry 16C and run on processing circuitry in control circuitry 16C to implement control operations for device 10 (e.g., data gathering operations, operations involving the adjustment of the components of device 10 using control signals, etc.). Control circuitry 16C in device 10 may include wired and wireless communications circuitry. For example, control circuitry 16C may include radio-frequency transceiver circuitry such as cellular telephone transceiver circuitry, wireless local area network (WiFi®) transceiver circuitry, millimeter wave transceiver circuitry, and/or other wireless communications circuitry.

Device 10 may be used in a system of multiple electronic devices. During operation, the communications circuitry of device 10 may be used to support communication between device 10 and other electronic devices in the system. For example, one electronic device may transmit video and/or audio data to device 10 or another electronic device in the system. Electronic devices in the system may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

The input-output devices of device 10 (e.g., input-output devices in components 16) may be used to allow a user to provide device 10 with user input. Input-output devices may also be used to gather information on the environment in which device 10 is operating. Output components in the input-output devices may allow device 10 to provide a user with output and may be used to communicate with external electrical equipment.

The input-output devices of device 10 may include one or more displays such as inner display 14 and external display 24. External display 24 may be formed from a liquid crystal display, organic light-emitting diode display, a display with an array of crystalline semiconductor light-emitting diode dies, or a display based on other types of pixels. In some configurations, a display in device 10 may include left and right display devices (e.g., display 14 may be formed from left and right components such as left and right scanning mirror display devices, liquid-crystal-on-silicon display devices, digital mirror devices, or other reflective display devices, left and right display panels based on light-emitting diode pixel arrays such as organic light-emitting display panels or display devices based on pixel arrays formed from crystalline semiconductor light-emitting diode dies, liquid crystal display devices panels, and/or or other left and right display devices in alignment with the user's left and right eyes, respectively). In other configurations, display 14 may include a single display panel that extends across both eyes or may use other arrangements in which content is provided with a single pixel array.

The display(s) of device 10 may be used to display visual content for a user of device 10. The content that is presented on display 14 may, for example, include virtual objects and other content that is provided to the display by control circuitry 16C and may sometimes be referred to as computer-generated content. An image on the display such as an image with computer-generated content may be displayed in the absence of real-world content or may be combined with real-world content. In some configurations, a real-world image may be captured by a camera (e.g., a forward-facing camera) so that computer-generated content may be electronically overlaid on portions of the real-world image (e.g., when device 10 is a pair of virtual reality goggles with an opaque display).

The input-output circuitry of device 10 may include sensors. The sensors may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze trackers (e.g., a gaze tracking system based on an image sensor and/or a photodetector, and, if desired, a light source such as an infrared light source that emits one or more beams of light that are tracked using the image sensor after reflecting from a user's eyes), touch sensors, buttons, capacitive proximity sensors, light-based (optical) proximity sensors, other proximity sensors, force sensors such as strain gauges, capacitive force sensors, resistive force sensors and/or other force sensors configured to measure force input from a user's fingers or other external objects on a display, track pad, or other input surface, sensors such as contact sensors based on switches, gas sensors, pressure sensors, moisture sensors, magnetic sensors, audio sensors (microphones), ambient light sensors, light sensors that make user measurements, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors (e.g., two-dimensional capacitive fingerprint sensors, two-dimensional optical fingerprint sensors, etc.), and/or other sensors.

Sensors in device 10 may include an ambient light sensor such as ambient light sensor 32. Ambient light sensor 32 may be a color ambient light sensor having an array of detectors each of which is provided with a color filter. If desired, the detectors in ambient light sensor 32 may be provided with color filters of different respective colors. Information from the detectors may be used to measure the total amount of ambient light that is present in the vicinity of device 10. For example, the ambient light sensor may be used to determine whether device 10 is in a dark or bright environment. Based on this information, control circuitry 16C can adjust display brightness for display 14 and/or display 24 or can take other suitable action.

Color ambient light sensor 32 may be used to make ambient light intensity (e.g., brightness, illuminance, and/or luminance flux per unit area) measurements. Ambient light intensity measurements, which may sometimes be referred to as ambient light illuminance measurements, may be used by device 10 to adjust display brightness (as an example). Color ambient light sensors 32 may be used to make measurements of ambient light color (e.g., color coordinates, correlated color temperature, or other color parameters representing ambient light color). Control circuitry 16C may be used to convert these different types of color information to other formats, if desired (e.g., a set of red, green, and blue sensor output values may be converted into color chromaticity coordinates and/or may be processed to produce an associated correlated color temperature, etc.). As an example, ambient light sensor 32 may obtain X, Y, and Z values associated with an XYZ color space.

Color information and illuminance information from color ambient light sensor 32 can be used to adjust the operation of device 10. For example, the color cast (e.g., display white point) of display 14 and/or display 24 (e.g., the white point of display 14 and/or display 24) may be adjusted in accordance with the color of ambient lighting conditions. The white point of a display may be a correlated color temperature setting (e.g., measured in degrees Kelvin) that determines the warmth or coolness of displayed colors. If, for example, a user moves device 10 from a cool lighting environment (e.g., an outdoor blue sky environment) to a warm lighting environment (e.g., an incandescent light environment), the warmth of display 14 and/or display 24 may be increased accordingly, so that the user of device 10 does not perceive display 14 as being overly cold and/or so that people around the user wearing device 10 do not perceive display 24 as being overly cold. If desired, ambient light sensor 32 may include an infrared light sensor. In general, any suitable actions may be taken based on color measurements and/or total light intensity measurements (e.g., adjusting display brightness, adjusting display content, changing audio and/or video settings, adjusting sensor measurements from other sensors, adjusting which on-screen options are presented to a user of device 10, adjusting wireless circuitry settings, etc.).

To convey information about the user's emotions and other information about the user's appearance and thereby help connect the user to people around the user, display 24 and/or other output components may be used in conveying information about the user's state to people in the vicinity of the user. The information that is conveyed using publicly viewable display 24 and/or other output components may include information on the user's appearance such as information on the appearance of the user's eyes and/or other facial features, information on the user's physiological state (e.g., whether the user is perspiring, is under stress, etc.), information on the user's emotions (e.g. whether the user is calm, upset, happy, sad, etc.), and/or other information on the state of the user. The information may be conveyed visually (e.g., using display 24 and/or light-emitting components such as light-emitting diode status indicator lights, dedicated visual output devices such as devices that illuminate icons, text, one or more different eye-shaped symbols, etc. without using a full pixel array, etc.) and/or may be conveyed in other forms (e.g., using sound such as tones, synthesized voice, sound clips, etc.). Illustrative configurations for device 10 in which information on the state of the user is displayed visually using a publicly viewable display such as display 24 may sometimes be described herein as an example.

Because display 24 is publicly viewable, visual information displayed on display 24 can be used to convey information about the state of the user to people who can view display 24 (e.g., people in the vicinity of the user). These people might normally be able to interact with the user by virtue of observing the user's eyes and other facial features that are now being obscured by the presence of device 10. By placing appropriate information on display 24, control circuitry 16C can convey information about the user to others. The information may include text, graphics, and/or other images and may include still and/or moving content. The information that is displayed may be captured image data (e.g., captured images such as photographs and/or videos of facial features associated with the user) and/or may be computer-generated images (e.g., text, graphics such as user facial feature graphics, computer-processed photographs and/or videos, etc.). In some situations, information gathered by control circuitry 16C using input-output circuitry and/or wireless circuitry may be used in determining the content to be displayed on display 24.

The information displayed on display 24 may be real (e.g., a genuine facial expression) or may be artificial (e.g., a synthetic facial expression that does not represent a user's true facial expression). Configurations in which the images that are displayed on display 24 are representative of a user's true state help the user communicate with surrounding people. For example, if a user is happy, displaying a happy facial expression on display 24 will help the user convey the user's happy state to surrounding people. Configurations in which images that are displayed on display 24 are not representative of the user's true state may also be used to convey information to other people. If desired, a copy of the outwardly displayed facial expression or other publicly displayed information may be displayed on the user's private display (e.g., in a corner region of the display, etc.) so that the user is informed of the current outward appearance of device 10.

The use of display 24 may help a user convey information about the user's identity to other people. Consider, as an example, a scenario in which display 24 displays a photographic image of the user's facial features. The displayed facial features of the user may correspond to facial features captured in real time using an inwardly facing camera such as inward-facing camera 102-I and/or may correspond to previously captured facial feature images (still and/or moving). By filling in portions of the user's facial features that are otherwise obscured due to the presence of device 10, display 24 may help people in the vicinity of the user recognize the identity and facial expressions of the user.

Facial features may be displayed using a 1:1 replication arrangement. For example, control circuitry 16C may use display 24 to display an image of the portion of the user's face that is covered by display 24 without magnification or demagnification. Perspective correction may be applied to displayed images so that an image that is displayed on display 24 slightly in front of the surface of the user's face (e.g., 1-10 cm in front) will appear as if it is located directly at the surface of the user's face. In other situations, processed and/or synthesized content may be displayed on display 24. For example, display 24 may be used to display user facial feature graphics (graphical representations of the facial features of a user of device 10) such as computer-generated eyes (e.g., graphics containing eyes that resemble the user's real eyes and/or that appear significantly different than the user's real eyes) and skin. The eyes may have a blink rate that tracks the user's measured actual blink rate. The user's blinks may be detected using an inwardly facing camera or other user monitoring sensor. The skin color that is displayed on display 24 may match the actual skin color of the user's face. If desired, the user's skin color may be captured with a camera in device 10 (or in another electronic device), measured with a color-sensitive light sensor, and/or may be determined based on user input. If desired, the computer-generated (control-circuitry-generated) eyes may have a computer-generated point-of-gaze that matches the user's measured point-of-gaze. The point-of-gaze may be measured using a gaze detection system in device 10. Other eye attributes may also be replicated such as pupil size or eye color. If desired, the eyes displayed on display 24 may have attributes that do not match the attributes of the user's eyes. For example, blink events, point-of-gaze, pupil size, eye color, and/or other eye attributes may be different for the computer-generated version of the eyes on display 24 than for the user's actual eyes.

Control circuitry 16C may adaptively adjust the skin color that is displayed on display 24 based on the color of ambient light measured with ambient light sensor 32 and/or one or more additional sensors in electronic device 10. As the color of ambient light in the environment surrounding device 10 changes, control circuitry 16C may adaptively adjust the skin color that is displayed on display 24 to account for the chromatic adaptation of the human visual system to different illuminants. For example, control circuitry 16C may adaptively adjust the white point of display 24 based on the color of ambient light to make sure that the skin tone on display 24 is perceived to be consistent in both warm and cool ambient lighting environments.

Outer display 24 may be configured to display different types of content depending on the display mode in which inner display 14 is operating. For example, in passthrough mode, captured camera images of the surrounding environment are displayed on inner display 14 without overlaid virtual display content. To inform nearby people that the user is viewing the surrounding environment on display 14, display 24 may be configured to display the user's face and eyes when device 10 is operating in passthrough mode. In mixed reality mode, both passthrough display content (captured camera images of the surrounding environment) and overlaid virtual image content may be displayed on display 14. To inform nearby people that the user is viewing the surrounding environment but is also viewing virtual image content, display 24 may be configured to display the user's face and eyes under an overlaid abstract layer (e.g., abstract shapes, colors, patterns, and/or other visual content without text or recognizable objects) when device 10 is operating in mixed reality mode. In virtual reality mode, the user is fully immersed in virtual image content on display 14 and is viewing little to no passthrough image content associated with the surrounding environment. To inform nearby people that the user is immersed in virtual reality content and is not attentive to the surrounding environment, display 24 may be used to display an abstract layer (without any face or eyes) when device 10 is operating in virtual reality mode.

If desired, control circuitry 16C may adapt the face layer on outer display 24 to the color of ambient light measured by sensor 32 without adapting the abstract layer on outer display 24 to the color of ambient light. This is merely illustrative, however. If desired, both the abstract layer and the face layer on outer display 24 may be adapted to the measured color of ambient light.

User input and other information may be gathered using sensors and other input devices in the input-output devices of device 10. If desired, device 10 may include haptic output devices (e.g., vibrating components overlapped by a display, portions of a housing wall, and/or other device structures), light-emitting diodes and other light sources, speakers such as car speakers for producing audio output, and other electrical components used for input and output. If desired, device 10 may include circuits for receiving wireless power, circuits for transmitting power wirelessly to other devices, batteries and other energy storage devices (e.g., capacitors), joysticks, buttons, and/or other components.

Some or all of housing 12 may serve as support structures (see, e.g., the portion of housing 12 formed by support structures 12T and the portion of housing 12 formed from support structures 12M and 12I). In configurations in which electronic device 10 is a head-mounted device (e.g., a pair of glasses, goggles, a helmet, a hat, etc.), structures 12T and 12M and/or other portions of housing 12 may serve as head-mounted support structures (e.g., structures forming a helmet housing, head bands/straps, temples in a pair of eyeglasses, goggle housing structures, and/or other head-mounted structures). The head-mounted support structures may be configured to be worn on a head of a user during operation of device 10 and may support display(s), lenses, sensors, other input-output devices, control circuitry, and/or other components.

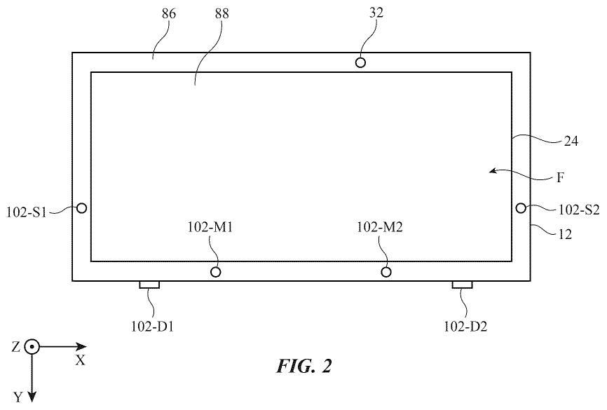

FIG. 2 is a front view of device 10 in an illustrative configuration in which front facing display 24 has been formed over most of front face F of housing 12. Sensors such as ambient light sensor 32, main cameras 102-M1 and 102-M2, downward-facing cameras 102-D1 and 102-D2, and side-facing cameras 102-S1 and 102-S2 may be formed along one or more portions of the peripheral edge of housing 12 on front face F.

Display 24 may include an array of display pixels formed from liquid crystal display (LCD) components, an array of electrophoretic pixels, an array of plasma pixels, an array of organic light-emitting diode pixels or other light-emitting diodes, an array of electrowetting pixels, or pixels based on other display technologies. The array of pixels of display 24 forms an active area 88. Active area 88 may be used to display images. Active area 88 may be rectangular, may have a non-rectangular shape (e.g., a shape of a pair of goggles), or may have other suitable shapes. Inactive border area 86 may run along one or more edges of active area 88. Inactive border area 86 may contain circuits, signal lines, and other structures that do not emit light for forming images. Sensors such as ambient light sensor 32, flicker sensors, infrared sensors, cameras (e.g., main cameras 102-M1 and 102-M2, downward-facing cameras 102-D1 and 102-D2, and side-facing cameras 102-S1 and 102-S2, etc.), depth sensors, and/or other sensors may be mounted in inactive border area 86 on front face F, if desired.

Main cameras 102-M1 and 102-M2, downward-facing cameras 102-D1 and 102-D2, and side-facing cameras 102-S1 and 102-S2 may capture images that are used in combination with data from ambient light sensor 32 to determine the luminance and chromaticity of ambient light in a physical environment around device 10. Ambient light sensor 32 may have an associated field of view. Using cameras 102-M1, 102-M2, 102-D1, 102-D2, 102-S1, and/or 102-S2 in addition to ambient light sensor 32 to determine the ambient light luminance and chromaticity for a physical environment may allow ambient light outside the field of view of ambient light sensor 32 to be accounted for in the ambient light measurements. The ambient light conditions determined using ambient light sensor 32 and cameras 102-M1, 102-M2, 102-D1, 102-D2, 102-S1, and/or 102-S2 may be used to adjust the skin color that is displayed on display 24.

To hide inactive circuitry (e.g., circuitry that does not include pixels for displaying images), sensors, and other components in border area 86 from view, the underside of a cover layer that covers display 24 (e.g., a cover glass layer, a tinted cover layer, or other cover layer on front face F) may be coated with an opaque masking material such as a layer of black ink. To accommodate optical components (e.g., a camera, a light-based proximity sensor, an ambient light sensor, status indicator light-emitting diodes, camera flash light-emitting diodes, etc.) that are mounted under inactive border area 86, one or more openings (sometimes referred to as windows) may be formed in the opaque masking layer of inactive region 86. For example, one or more a light component windows may be formed in a peripheral portion of display 24 in inactive border area 86. Each light component window may cover at least one of sensor 32 and cameras 102-M1, 102-M2, 102-D1, 102-D2, 102-S1, and 102-S2 may include ink having a higher transmission than the surrounding ink in inactive border 86 so that ambient light can reach sensor 32 and cameras 102-M1, 102-M2, 102-D1, 102-D2, 102-S1, and/or 102-S2 while sensor 32 and cameras 102-M1, 102-M2, 102-D1, 102-D2, 102-S1, and/or 102-S2 remain obscured by the ink.

Each one of cameras 102-M1, 102-M2, 102-D1, 102-D2, 102-S1, and 102-S2 may be a color camera (e.g., configured to sense multiple colors of visible light such as red, green, and blue) or a monochrome camera. As one example, cameras 102-M1 and 102-M2 may be color cameras whereas cameras 102-D1, 102-D2, 102-S1, and 102-S2 may be monochrome cameras.

Each one of cameras 102-M1, 102-M2, 102-D1, 102-D2, 102-S1, and 102-S2 may have a unique field of view. Each camera may be characterized as pointing in a direction that is centered within the field of view. For example, main cameras 102-M1 and 102-M2 may point approximately parallel to the Z-axis to capture images of the area immediately in front of device 10. Downward-facing cameras 102-D1 and 102-D2, meanwhile, may point substantially in the negative Y-direction and may, as an example, capture images of a user's hands while a user wears device 10. The directions associated with cameras 102-M1 and 102-D1 may differ by at least 30 degrees within the YZ-plane, at least 45 degrees within the YZ-plane, at least 60 degrees within the YZ-plane, etc.

Side-facing cameras 102-S2 may point in directions that are non-parallel with the Z-axis in order to capture images of a greater portion of the physical environment surrounding device 10. As an example, side-facing camera 102-S1 may point at a 45 degree angle in the negative X-direction relative to the Z-axis whereas side-facing camera 102-S1 may point at a 45 degree angle in the positive X-direction relative to the Z-axis. The directions associated with cameras 102-M1 and 102-S1 may differ by at least 20 degrees within the XZ-plane, at least 30 degrees within the XZ-plane, at least 45 degrees within the XZ-plane, at least 60 degrees within the XZ-plane, etc. The directions associated with cameras 102-M2 and 102-S2 may differ by at least 20 degrees within the XZ-plane, at least 30 degrees within the XZ-plane, at least 45 degrees within the XZ-plane, at least 60 degrees within the XZ-plane, etc. The directions associated with cameras 102-M1 and 102-M2 may be approximately parallel (e.g., within 10 degrees, within 5 degrees, within 3 degrees, etc.).

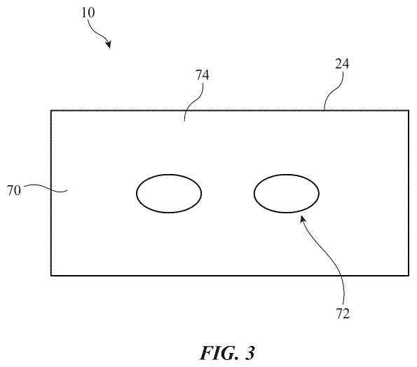

As a user wears device 10 and views display content on inner display 14, outer display 24 may be used to inform nearby people of the status of device 10 and/or the status of the user wearing device 10. For example, display content on display 24 may be adjusted based on the operating mode of device 10 and/or the display mode of inner display 14. FIG. 3 is a front view of display 24 showing illustrative display content that may be displayed on outer display 24

In the example of FIG. 3, device 10 and inner display 14 are operating in passthrough mode. In passthrough mode, captured images of the user's environment are displayed on inner display 14 with minimal or no overlaid virtual image content. The user is therefore able to view the real-world environment on display 14 without any virtual distractions. In this type of scenario, outer display 24 may be used to display face layer 70 to let nearby people know that the user is aware of the real-world environment. In passthrough mode, face layer 70 may be displayed on display 24 with minimal or no overlaid image content. Face layer 70 may include camera-captured and/or computer-generated facial features such as skin 74 and eyes 72. Eyes 72 may track the user's gaze so that eyes 72 have a point-of-gaze that matches the actual user's point-of-gaze as the user views passthrough content on inner display 14. The color of skin 74 of face layer 70 may be based on user input or may be based on gathered sensor data (e.g., the user's skin color may be captured using an inward-facing camera or other sensor in device 10, using a camera in an external electronic device, using a color light sensor, and/or using other suitable sensors and/or user input). The skin color may be detected/determined during a dedicated enrollment process or may be gathered during normal use of device 10.

In passthrough mode, control circuitry 16C may adjust the color of skin 74 on outer display 24 based on the color of ambient light measured by ambient light sensor 32 to ensure that the skin color is perceived to be consistent under different illuminants. This may include, for example, adaptively adjusting the white point of face layer 70 to be colder (e.g., bluer) under cool ambient light illumination and to be warmer (e.g., redder) under warm ambient light illumination.

A user's skin tone may be captured by a camera (e.g., an inward-facing camera in device 10, a forward-facing camera in device 10, a camera that is part of another electronic device, etc.). In particular, a face image (e.g., a captured image of the user's face) may have forehead regions and cheek regions from which an aggregate skin color can be extracted. The skin color may be represented in any suitable color space. In some arrangements, the skin color may be represented in a perceptually uniform color space such as Lab color space or Yu′v′ color space.

In other situations, device 10 and inner display 14 may be operating in a mixed reality mode. In the mixed reality mode, captured images of the user's environment are displayed on inner display 14, and virtual image content such as computer-generated virtual display elements are overlaid onto (e.g., layered with) the passthrough content. The user is therefore able to view the real-world environment on display 14 but may not be fully attentive to the real-world surroundings due to the presence of virtual content on display 14. In this type of scenario, outer display 24 may be used to display face layer 70 to let nearby people know that the user is aware of the real-world environment, and an additional layer such as an abstract layer may be overlaid onto (e.g., layered with) face layer 70. The abstract layer may include abstract colors, shapes, patterns, content that is free of recognizable objects or text, and/or other display content.

In the mixed reality mode, control circuitry 16C may adjust the color of skin 74 on outer display 24 based on the color of ambient light measured by ambient light sensor 32 to ensure that the skin color is perceived to be consistent under different illuminants. This may include, for example, adaptively adjusting the white point of face layer 70 to be colder (e.g., bluer) under cool ambient light illumination and to be warmer (e.g., redder) under warm ambient light illumination.

If desired, control circuitry 16C may adapt face layer 70 to the color of ambient light without adapting abstract layer 76 to the color of ambient light. For example, face layer 70 may have an adjustable white point that shifts with the color of ambient light (thereby allowing skin 74 and eyes 72 to be perceived as consistent under different illuminants), while the abstract layer may have a fixed white point that remains constant under different illuminants. While the white point of the abstract layer may remain fixed, the brightness of the abstract layer may be adjusted to adapt to the measured brightness of ambient light. This is merely illustrative, however. If desired, control circuitry 16C may adaptively adjust the white point of the abstract layer based on the color of ambient light.

In other situations, device 10 and inner display 14 may be operated in a virtual reality mode. In the virtual reality mode, most or all of the display content on display 14 is virtual content and/or other content that does not represent the user's current real-world environment. The user is fully immersed in a virtual world that is displayed on display 14 and is not attentive to the people or objects in the user's real-world environment. In this type of scenario, outer display 24 may be used to display the abstract layer to let nearby people know that the user is not aware of and/or cannot see the real-world environment. The abstract layer may include abstract colors, shapes, patterns, content that is free of recognizable objects or text, and/or other display content. In virtual reality mode, the abstract layer may be displayed on display 24 with minimal or no overlaid image content (e.g., without face layer 70).

In virtual reality mode, the abstract layer may have a fixed white point that remains constant under different illuminant colors. This is merely illustrative, however. If desired, control circuitry 16C may adaptively adjust the white point of the abstract layer based on the color of ambient light when device 10 is operating in virtual reality mode.

In other situations, device 10 and inner display 14 may be operated in an off state or a reboot state. For example, display 14 may be turned off, device 10 may be resting on a table or otherwise not on a user's head, and/or display 14 may be powering up after a reboot. In these and other scenarios, outer display 24 may be used to a display user interface layer. The user interface layer may include user interface elements, such as low battery icons, charging status icons, pairing status information, menu buttons, user-selectable on-screen options, user login information, authentication options, and/or other information.

The user interface layer may have a fixed white point that remains constant under different illuminant colors. This is merely illustrative, however. If desired, control circuitry 16C may adaptively adjust the white point of the user interface layer based on the color of ambient light.

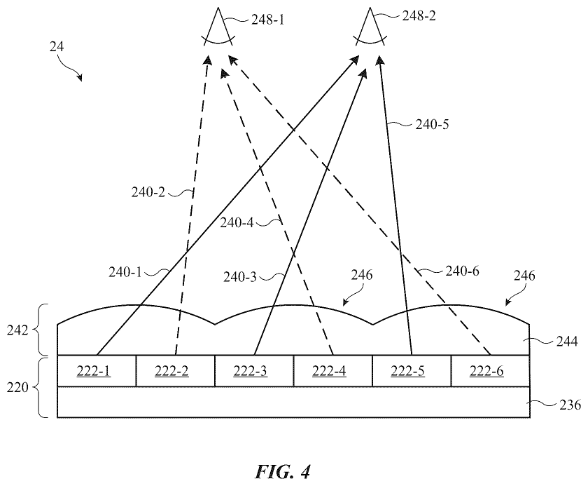

Display 24 may be a three-dimensional display such as a lenticular display. FIG. 4 is a cross-sectional side view of an illustrative lenticular display that may be incorporated into electronic device 10. Display 24 includes a display panel 220 with pixels 222 on substrate 236. Substrate 236 may be formed from glass, metal, plastic, ceramic, or other substrate materials and pixels 222 may be organic light-emitting diode pixels, liquid crystal display pixels, or any other desired type of pixels.

As shown in FIG. 4, lenticular lens film 242 may be formed over display pixels 222. Lenticular lens film 242 (sometimes referred to as a light redirecting film, a lens film, etc.) includes lenses 246 and a base film portion 244 (e.g., a planar film portion to which lenses 246 are attached). Lenses 246 may be lenticular lenses that extend along respective longitudinal axes (e.g., axes that extend into the page parallel to the Y-axis). Lenses 246 may be referred to as lenticular elements 246, lenticular lenses 246, optical elements 246, etc.

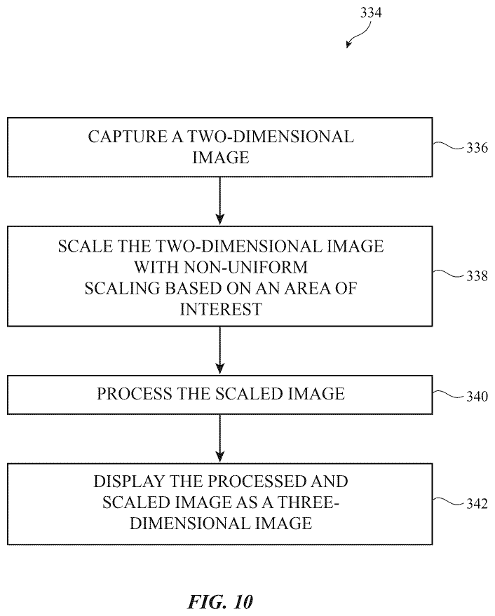

The lenses 246 of the lenticular lens film cover the pixels of display 24. An example is shown in FIG. 10 with display pixels 222-1, 222-2, 222-3, 222-4, 222-5, and 222-6. In this example, display pixels 222-1 and 222-2 are covered by a first lenticular lens 246, display pixels 222-3 and 222-4 are covered by a second lenticular lens 246, and display pixels 222-5 and 222-6 are covered by a third lenticular lens 246. The lenticular lenses may redirect light from the display pixels to enable stereoscopic viewing of the display.

Consider the example of display 24 being viewed by a viewer with a first eye (e.g., a right eye) 248-1 and a second eye (e.g., a left eye) 248-2. Light from pixel 222-1 is directed by the lenticular lens film in direction 240-1 towards left eye 248-2, light from pixel 222-2 is directed by the lenticular lens film in direction 240-2 towards right eye 248-1, light from pixel 222-3 is directed by the lenticular lens film in direction 240-3 towards left eye 248-2, light from pixel 222-4 is directed by the lenticular lens film in direction 240-4 towards right eye 248-1, light from pixel 222-5 is directed by the lenticular lens film in direction 240-5 towards left eye 248-2, and light from pixel 222-6 is directed by the lenticular lens film in direction 240-6 towards right eye 248-1. In this way, the viewer's right eye 248-1 receives images from pixels 222-2, 222-4, and 222-6, whereas left eye 248-2 receives images from pixels 222-1, 222-3, and 222-5. Pixels 222-2, 222-4, and 222-6 may be used to display a slightly different image than pixels 222-1, 222-3, and 222-5. Consequently, the viewer may perceive the received images as a single three-dimensional image.

Pixels of the same color may be covered by a respective lenticular lens 46. In one example, pixels 222-1 and 222-2 may be red pixels that emit red light, pixels 222-3 and 222-4 may be green pixels that emit green light, and pixels 222-5 and 222-6 may be blue pixels that emit blue light. This example is merely illustrative. In general, each lenticular lens may cover any desired number of pixels each having any desired color. The lenticular lens may cover a plurality of pixels having the same color, may cover a plurality of pixels each having different colors, may cover a plurality of pixels with some pixels being the same color and some pixels being different colors, etc.

In some arrangements, the stereoscopic display may have two or more optimal viewing positions (e.g., two or more viewing positions where the images from the display are perceived as three-dimensional). Indeed, the stereoscopic display images such that a viewer perceives three-dimensional images across a relatively wide range of viewing angles.

It should be understood that the lenticular lens shapes and directional arrows of FIG. 4 are merely illustrative. The actual rays of light from each pixel may follow more complicated paths (e.g., with redirection occurring due to refraction, total internal reflection, etc.). Additionally, light from each pixel may be emitted over a range of angles. The lenticular display may also have lenticular lenses of any desired shape or shapes. Each lenticular lens may have a width that covers two pixels, three pixels, four pixels, more than four pixels, more than ten pixels, etc. Each lenticular lens may have a length that extends across the entire display (e.g., parallel to columns of pixels in the display).

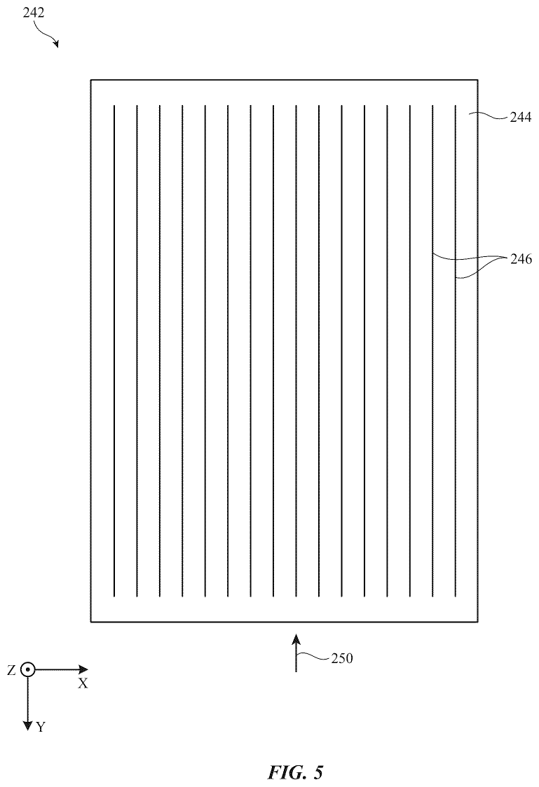

FIG. 5 is a top view of an illustrative lenticular lens film that may be incorporated into a lenticular display. As shown in FIG. 5, elongated lenses 246 extend across the display parallel to the Y-axis. The lenticular display may include any desired number of lenticular lenses 246 (e.g., more than 10, more than 100, more than 1,000, more than 10,000, etc.). In FIG. 5, the lenticular lenses extend perpendicular to the upper and lower edge of the display panel. This arrangement is merely illustrative, and the lenticular lenses may instead extend parallel to the X-axis or at a non-zero, non-perpendicular angle (e.g., diagonally) relative to the display panel if desired.

Three-dimensional display 24 may be capable of providing unique images at different viewing positions of display 24. Control circuitry 16C may control display 24 to display desired images at different viewing positions. There is much flexibility in how the display provides images to the different viewing positions. Display 24 may display entirely different content at different viewing positions of the display. For example, an image of a first object (e.g., a cube) may displayed for position 1, an image of a second, different object (e.g., a pyramid) may be displayed for position 2, an image of a third, different object (e.g., a cylinder) may be displayed for position 3, etc. This type of scheme may be used to allow different viewers to view entirely different scenes from the same display.

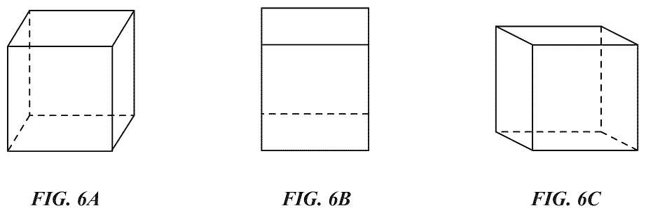

In another possible use-case, display 24 may display a similar image for each viewing position, with slight adjustments for perspective between each position. This may be referred to as displaying the same content at different perspectives, with one image corresponding to a unique perspective of the same content. For example, consider an example where the display is used to display a three-dimensional cube. The same content (e.g., the cube) may be displayed on all of the different positions in the display. However, the image of the cube provided to each viewing position may account for the viewing angle associated with that particular position. In a first position, for example, the viewing cone may be at a −10° angle relative to the surface normal of the display. Therefore, the image of the cube displayed for the first position may be from the perspective of a −10° angle relative to the surface normal of the cube (as in FIG. 6A). A second position, in contrast, is at approximately the surface normal of the display. Therefore, the image of the cube displayed for the second position may be from the perspective of a 0° angle relative to the surface normal of the cube (as in FIG. 6B). A third position may be at a 10° angle relative to the surface normal of the display. Therefore, the image of the cube displayed for the third position may be from the perspective of a 10° angle relative to the surface normal of the cube (as in FIG. 6C). As a viewer progresses from the first position to the third position in order, the appearance of the cube gradually changes to simulate looking at a real-world object. Three-dimensional display 24 may use this type of technique to display images of a user's face that, as a viewer progresses through different viewing angles, gradually change to simulate looking at a real-world face.

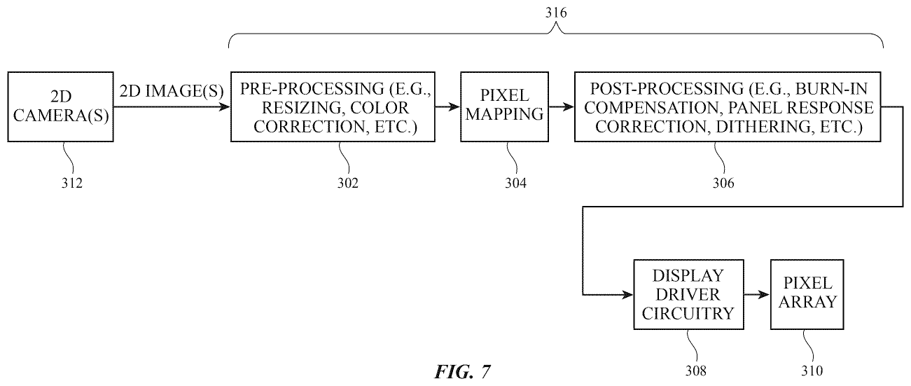

FIG. 7 is a schematic diagram of display pipeline circuitry within electronic device 10. As shown in FIG. 7, electronic device 10 may include a pre-processing block 302, a pixel mapping block 304, and a post-processing block 306. Pre-processing block 302, pixel mapping block 304, and post-processing block 306 may sometimes collectively be referred to as display pipeline circuitry 316.

Display pipeline circuitry 316 may be based on one or more microprocessors (e.g., processors), microcontrollers, digital signal processors, baseband processors, power management units, audio chips, graphics processing units, application specific integrated circuits, and other integrated circuits. Software code may be stored on storage in display pipeline circuitry 316 and run on processing circuitry in display pipeline circuitry to implement control operations (e.g., data gathering operations, operations involving the adjustment of display pipeline circuitry 316 using control signals from device 10, etc.).

Pre-processing block 302 (sometimes referred to as pre-processing circuitry 302) may receive one or more two-dimensional (2D) images as an input. In one illustrative example shown in FIG. 7, the 2D image(s) may be received by pre-processing block 302 from a two-dimensional camera 312. The two-dimensional camera 312 may be, as an example, an inward-facing camera such as inward-facing camera 102-I in FIG. 1 that is configured to capture images of a user's face while device 10 is worn by a user. The pre-processing performed by block 302 may include a wide variety of processing of the 2D image. The pre-processing may change the brightness level of one or more pixels within the 2D image.

Pre-processing circuitry 302 may be used to adjust each two-dimensional image to improve sharpness and mitigate aliasing. Once the two-dimensional image is ultimately displayed on pixel array 310 for viewing, the lenticular lenses in the display anisotropically magnify the image. For example, using the lenticular lens arrangement of FIG. 5, the lenticular lenses magnify light in the X-dimension while not magnifying the light in the Y-dimension. This example is merely illustrative and the lenticular lenses may alternatively magnify light in the Y-dimension while not magnifying the light in the X-dimension or may magnify light in both the X-dimension and the Y-dimension. In any of these arrangements, the magnification may be greater in one dimension than another (e.g., greater in the X-dimension than the Y-dimension or vice versa). This anisotropic magnification may cause aliasing in the image perceived by the user.

Pre-processing circuitry 302 may apply an anisotropic low-pass filter to the two-dimensional image. This mitigates aliasing when the pre-processed image is displayed and perceived by a viewer. As another option, the content may be resized by pre-processing circuitry 302. In other words, pre-processing circuitry 302 may change the aspect ratio of the two-dimensional image for a given view (e.g., by shrinking the image in the X-direction that is affected by the lenticular lenses). Anisotropic resizing of this type mitigates aliasing when the pre-processed image is displayed and perceived by the viewer.

Pre-processing may also include various color operations such as tone mapping (e.g., selecting a content-luminance to display-luminance mapping), adjusting color based ambient light level and/or ambient light color (e.g., using ambient light information received by ambient light sensor 32 and one or more cameras 102 in device 10), adjusting color based on brightness settings, saturation adjustment, etc.

Pixel mapping block 304 (also referred to as pixel mapping circuitry 304) may use a three-dimensional image (e.g., captured by an inward-facing three-dimensional camera that captures images of a user's face while device 10 is worn by a user) to map the two-dimensional image that is intended to be displayed on display 14 (e.g., the 2D image received from pre-processing block 302) to the pixel array of display 24. For every sub-pixel of the display, pixel mapping circuitry 304 obtains a corresponding color value from the two-dimensional image that is intended to be displayed on display 24. The output of pixel mapping block 304 may be referred to as a three-dimensional (3D) image. The 3D image presents the content (e.g., the user's face) from different perspectives at multiple views.

After pixel mapping is performed, the array of brightness values for the pixel array may undergo post-processing at block 306 (also referred to as post-processing circuitry 306). The post-processing may include border masking (e.g., imparting a desired shape to the light-emitting area of the display such as a rectangular shape with rounded corners), burn-in compensation (e.g., compensating the pixel data to mitigate risk of burn-in and/or mitigate visible artifacts caused by burn-in), panel response correction (e.g., mapping luminance levels for each pixel to voltage levels using a gamma curve), color compensation (e.g., using a color lookup table), dithering (e.g., randomly adding noise to the luminance values to reduce distortion when the image is ultimately displayed by the pixel array, manipulated by the lenticular lenses, and viewed by the viewer), etc.

After post-processing is complete, target pixel voltages for each pixel in display 24 may be provided to display driver circuitry 308. Display driver circuitry 308 provides the target pixel voltages to pixel array 310 using data lines. The images are then displayed on display 24.

Pre-processing block 302 is performed before pixel mapping and therefore may sometimes be referred to as pre-mapping block 302, pre-mapping circuitry 302, pre-mapping-processing block 302, pre-mapping-processing circuitry 302, etc. Post-processing block 306 is performed after pixel mapping and therefore may sometimes be referred to as post-mapping block 306, post-mapping circuitry 306, post-mapping-processing block 306, post-mapping-processing circuitry 306, etc.

Pixel mapping circuitry 304 may perform the pixel mapping operations for each display frame (e.g., at a frequency that is equal to the display frame rate). Similarly, pre-processing 302 and post-processing 306 may be performed at a frequency that is equal to the display frame rate.

If desired, viewing angle dependent adjustments may be made during pixel mapping block 304 and/or post-processing block 306. An approximate viewing angle may be associated with each pixel in display 24. In other words, the geometry of the lenticular lens film over display 24 may cause a given pixel to emit light in a given direction. The given direction has an associated viewing angle. The viewing angle for each pixel may be stored in memory in control circuitry 16C, as one example. During pixel mapping or post-processing, color correction may be performed on a given pixel as a function of the viewing angle associated with that pixel, the spatial ambient light map generated by ambient light mapping circuitry 104, one or more color correction values generated by ambient light mapping circuitry 104, and/or any other desired factors.

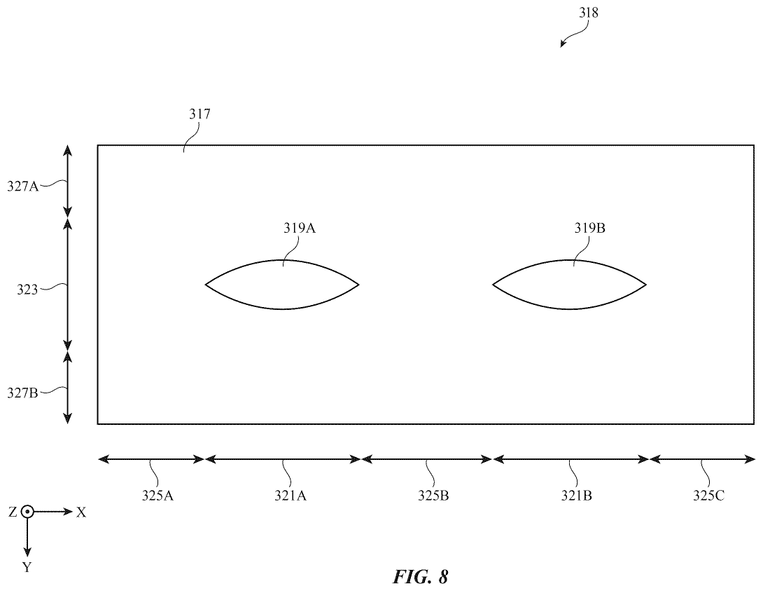

The content displayed on three-dimensional display 24 may be adjusted to reduce the power consumption of three-dimensional display 24, display pipeline circuitry 316, display driver circuitry 308, two-dimensional camera(s) 312, and/or other components of the display pipeline. To reduce power consumption while displaying desired images, such as images of a user's face, on three-dimensional display 24, the images may be scaled non-uniformly based on predetermined attributes in the content of the images. In other words, the images may have regions that are scaled differently from one another. An illustrative example is shown in FIG. 8.

As shown in FIG. 8, image 318 may include regions 317 and 319. Image 318 may be displayed on a display, such as three-dimensional display 24 of FIGS. 1-3. Regions 317 and 319 may correspond with known (predetermined) regions in image 318. Regions 319A and 319B may correspond with a user's eyes, while region 317 may correspond with the user's skin (e.g., the user's face adjacent to the user's eyes). In particular, regions 319A and 319B may be known/predetermined based on a limited domain of image 318 (e.g., the user's face). In other words, regions 319A and 319B may correspond with predetermined attributes of the content of image 318.

Regions 319A and 319B may be high-resolution zones, while region 317 may be a low-resolution zone. In other words, it may be desirable to display details of regions 319A and 319B (e.g., predetermined attributes in the image that correspond with the user's eyes), which may have high complexity, with more resolution than details of region 317 (e.g., predetermined attributes in the image that correspond with the user's skin), which may have relatively lower complexity. Therefore, regions 319A and 319B may be scaled with a first predetermined scaling 321A and 321B in the X-direction and a first predetermined scaling 323 in the Y-direction. In contrast, region 317 may be scaled with a second predetermined scaling 325A, 325B, and 325C in the X-direction and a second predetermined scaling 327A and 327B in the Y-direction. First predetermined scalings 321 and 323 may be greater than second predetermined scalings 325 and 327. For example, first predetermined scalings 321 and 323 may be at least 30%, at least 40%, between 30% and 50%, or other suitable scaling value relative to an original (unscaled) image. Second predetermined scalings 325 and 327 may be at least 10%, at least 20%, between 10% and 30%, or other suitable scaling value relative to the original (unscaled) image. In this way, region 317 may be reduced more than regions 319 in image 318 relative to the original (unscaled) image, and image 318 may retain the high-complexity details of 319 while reducing power consumption.

First predetermined scalings 321 and 323 may be the same or may be different from one another. Similarly, first predetermined scaling 321A and first scaling 321B may be the same or may be different from one another. Second predetermined scalings 325 and 327 may be the same or may be different from one another. Similarly, second predetermined scaling 325A, second predetermined scaling 325B, and second predetermined scaling 325C may be the same or may be different from one another, and second predetermined scaling 327A and second predetermined scaling 327B may be the same or may be different from one another. In general, first predetermined scalings 321 and 323 and second predetermined scalings 325 and 327 may have any suitable non-uniform scaling.

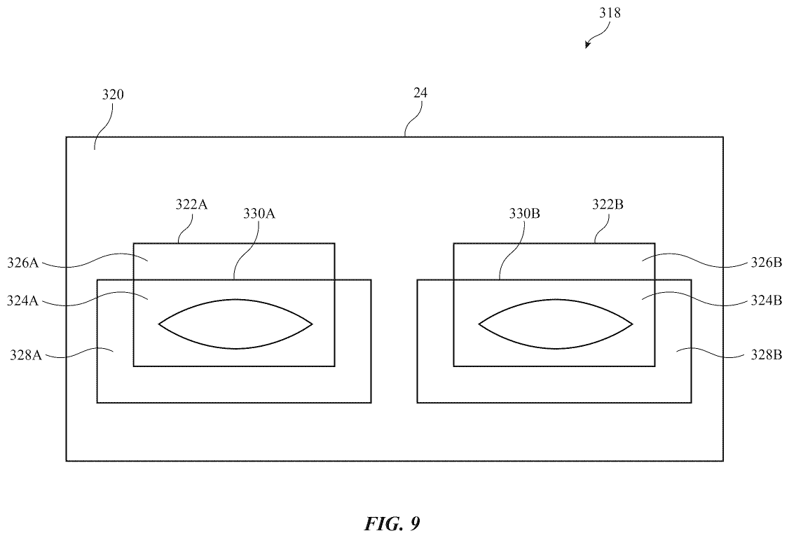

Although FIG. 8 shows image 318 having regions 317 and 319 with different scaling values, this is merely illustrative. In general, image 318 may have one or more known/predetermined regions of interest (e.g., regions that correspond with predetermined attributes of the content of image 318), and the region(s) of interest may be scaled non-uniformly with predetermined scalings. An illustrative example is shown in FIG. 9.

As shown in FIG. 9, image 318, which may be displayed on a display such as display 24 (FIGS. 1-3), may include first regions 324A and 324B, second regions 326A and 326B, third regions 328A and 328B, and fourth region 320. Each of first regions 324, second regions 326, third regions 328, and fourth region 320 may correspond with areas of interest in image 318. In other words, first regions 324, second regions 326, and third regions 328 may have higher complexity than fourth region 320, and it may be desirable to display regions 324, 326, and 328 with greater resolution than fourth region 320.

First regions 324A and 324B, second regions 326A and 326B, third regions 328A and 328B, and fourth region 320 may be known/predetermined regions based on predetermined attributes of the contents of image 318. In particular, image 318 may be an image of a user's face or other limited domain, which may allow first regions 324A and 324B, second regions 326A and 326B, third regions 328A and 328B, and fourth region 320 to be known/predetermined. In some illustrative embodiments, first regions 324 may correspond with the predetermined attribute of a user's eyes, second regions 326 may correspond with a predetermined attribute of the user's eyebrows, fourth region 320 may correspond with a predetermined attribute the user's skin, and third regions 328 may correspond with buffer regions between the user's eyes to the user's skin. However, this is merely illustrative. In general, image 318 may have any suitable number of known/predetermined areas of interest based on one or more predetermined attributes of the content in image 318, and the known/predetermined areas of interest may correspond with any suitable feature(s) within the image. For example, additional buffer regions 330A and 330B may be included in the image and correspond with a transition between the user's eye to the user's eyebrow (e.g., between adjacent known/predetermined areas of interest). Alternatively or additionally, buffer regions 322A and 322B may be included in the image and correspond with a transition between the user's eyebrow and skin.

Each of first regions 324, second regions 326, third regions 328, and fourth region 320 (along with any other suitable region(s)) may be scaled differently from one another with predetermined scalings based on the known/predetermined areas of interest. In other words, image 318 may have non-uniform scaling or varied scaling. For example, first regions 324 may be scaled to at least 30%, at least 40%, between 30% and 50%, or other suitable predetermined scaling value relative to an original (unscaled) image. Second regions 326 may be scaled to at least 20%, at least 30%, between 20% and 40%, or other suitable predetermined scaling value relative to the original (unscaled) image. Third regions 328 may be scaled to at least 20%, at least 30%, between 20% and 40%, or other suitable predetermined scaling value relative to the original (unscaled) image. Fourth region 320 may be scaled to at least 10%, at least 20%, between 10% and 30%, or other suitable predetermined scaling relative to the original (unscaled) image.

However, these are merely illustrative of the scaling of regions 324, 326, 328, and 320. In some embodiments, it may be desirable to scale regions 324, 326, 328, and 320 above a just noticeable difference (JND) value based on the known/predetermined areas of interest. For example, higher complexity regions, such as first regions 324A, may have higher JND scaling values than lower complexity regions, such as fourth region 320. In other words, scaling higher complexity regions may be more noticeable than scaling lower complexity regions, so lower complexity regions may be reduced more than the higher complexity regions. In general, however, at least some of first regions 324, second regions 326, third regions 328, and/or fourth region 320 may have varied scaling of any suitable value(s). In this way, image 318 may be displayed with non-uniform scaling to reduce power consumption.

Regions of interest in image 318, such as regions 324, 326, and/or 328, may be located heuristically and may be applied to all users of device 10 based on the predetermined attributes in the content of image 318. For example, regions 324 may account for at least 10% of image 318, at least 15% of image 318, or between 10% and 20% of image 318, as illustrative examples, regardless of the user of device 10. Combined regions 324 may be centered within image 318, or may be offset in any desired manner. Similarly, regions 326 may account for at least 7%, at least 12%, or between 7% and 15% of image 318, as examples. Regions 326 may be above regions 324. Regions 328 may account for at least 7%, at least 12%, or between 7% and 15% of image 318 as examples, and may wrap around lower portions of regions 324. However, these sizes and locations of regions 324, 326, and 328 are merely illustrative. In general, regions 324, 326, and/or 328 may have any suitable size(s) and/or location(s) in image 318. Additionally or alternatively, other areas of interest may be used. In this way, areas of interest, such as regions 324, 326, and/or 328 may apply to all users of device 10.

However, the use of heuristic regions that apply to all users of device 10 is merely illustrative. In some embodiments, one or more sensors in device 10, such as camera 102-1 (FIG. 1) and/or gaze trackers (or pupil trackers or other suitable eye trackers) in control circuitry 16C, may be used to locate the known regions of interest in image 318 actively. For example, the positions of the user's eyes (a predetermined attribute based on the domain of the user's face) may be tracked actively using an inwardly-facing gaze tracker, allowing regions 324A and 324B of image 318 to correspond exactly with the positions of the eyes. However, this is merely illustrative. In general, any desired region(s) of interest may be tracked actively using one or more sensors in device 10.

An image to be displayed on display 24 may be scaled non-uniformly by circuitry at any suitable point in the display pipeline (e.g., the pipeline of FIG. 7). For example, a non-scaled image may be captured by two-dimensional camera(s) 312, and the image may be scaled non-uniformly using one or more of the blocks in display pipeline circuitry 316 and/or by display driver circuitry 308. An illustrative example of method steps that may be used to scale an image non-uniformly is shown in FIG. 10.

As shown in FIG. 10, at step 336 of illustrative flowchart 334, a two-dimensional image may be captured. For example, one or more two-dimensional cameras, such as two-dimensional camera(s) 312 of FIG. 7, may be used to capture the two-dimensional image. The captured image may be an unscaled image, or may be scaled to some extent by two-dimensional camera(s) and/or associated processing circuitry.

At step 338, the two-dimensional image may be scaled with non-uniform scaling based on a known/predetermined area of interest in the image based on a predetermined attribute in the content of the image. In particular one or more predetermined attributes may be located in the image, such as using heuristic-based regions (e.g., as shown in FIG. 9) or by tracking areas of interest (e.g., a user's eye) using one or more sensors (e.g., gaze trackers, pupil trackers, one and/or more additional cameras, etc.) to define the one or more known/predetermined areas of interest. Once the one or more areas of interest are defined, the area(s) of interest may be scaled with predetermined, varied (non-uniform) scaling from one another and/or from the other regions of the image. The predetermined non-uniform scaling may be performed by processors in and/or associated with the one or more two-dimensional cameras, one or more blocks in display pipeline circuitry 316, and/or display driver circuitry 308 (FIG. 7). In this way, a non-uniform scaled image may be produced.

At step 340, the non-uniform scaled image may be processed. For example, the remaining block(s) of display pipeline circuitry 316 and/or display driver circuitry 308 (FIG. 7) may process the non-uniform scaled image. In particular, the image may be resized, color-corrected, pixel mapped, compensated for burn in, dithered, and/or otherwise processed.

At step 342, the processed and non-uniform scaled image may be displayed as a three-dimensional image. For example, the processed and non-uniform scaled image may be output to pixel array 310 (FIG. 7) of display 24 (FIGS. 1-4). In this way, a non-uniform scaled image may be displayed on display 24, reducing power consumption of display 24 and/or the associated processing circuitry.

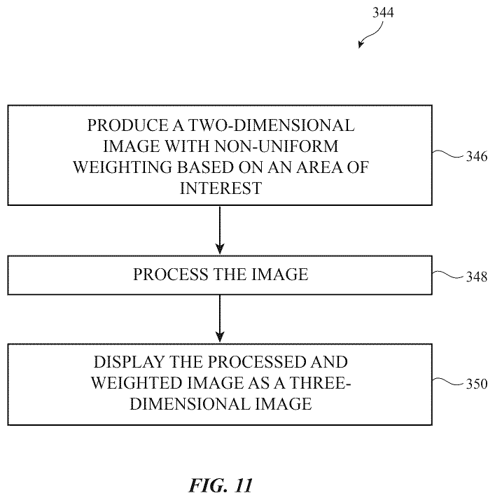

Although FIG. 10 shows an unscaled two-dimensional image being produced by a two-dimensional camera and later scaled non-uniformly by processing circuitry, this is merely illustrative. In some embodiments, a two-dimensional camera may non-uniformly weight portion(s) of a scene while capturing an image based on one or more known/predetermined areas of interest. An illustrative example is shown in FIG. 11.

As shown in FIG. 11, at step 346 of illustrative flowchart 344, a two-dimensional image may be captured. For example, one or more two-dimensional cameras, such as two-dimensional camera(s) 312 of FIG. 7, may be used to capture the two-dimensional image. While capturing the two-dimensional image, the two-dimensional camera(s) (e.g., processing circuitry (one or more processors) in and/or associated with the two-dimensional camera(s)) may weight portions of the image based on one or more known/predetermined areas of interest.

In particular, one or more known/predetermined areas of interest may be defined in the scene of which the camera(s) is/are capturing the image based on predetermined attributes of the scene/image. The area(s) of interest may be defined by a machine learning (ML) model that is trained to provide greater weight (e.g., definition and resolution) on high-complexity areas. For example, the ML algorithm may weight an area with a user's eyes greater than an area with the user's skin to provide additional resolution of the eyes in the final image. The ML algorithm may leverage heuristic-based regions (e.g., as shown in FIG. 9) and/or tracked areas of interest (e.g., a user's eye) using one or more sensors in the device.

Once the one or more areas of interest are defined, the area(s) of interest may be weighted with a predetermined, varied (non-uniform) weighting from one another and/or from the other regions of the image using the processor(s) in the camera(s). The area(s) may be weighted with resolution weight percentages in the same manner as image 318 is described as being scaled in connection with FIG. 9, as an example. In this way, the camera(s) and/or associated processor(s) may directly output an image with non-uniform weighting.

At step 348, the non-uniform weighted image may be processed. For example, the display pipeline circuitry 316 and/or display driver circuitry 308 (FIG. 7) may process the non-uniform weighted image. In particular, the image may be resized, color-corrected, pixel mapped, compensated for burn in, dithered, and/or otherwise processed.

At step 350, the processed and non-uniform weighted image may be displayed as a three-dimensional image. For example, the processed and non-uniform weighted image may be output to pixel array 310 (FIG. 7) of display 24 (FIGS. 1-4). In this way, a non-uniform weighted image may be displayed on display 24, reducing power consumption of display 24 and/or the associated processing circuitry.

The processes of FIGS. 10 and 11 may be operated independently or together in any combination. For example, a two-dimensional camera may produce a non-uniform weighted image, and the non-uniform weighted image may be scaled in the display processing pipeline.

Although the examples of FIGS. 3-11 have shown and described determining area(s) of interest in an image (or a scene to be imaged) based on one or more features of a user's face, this is merely illustrative. In general, one or more known/predetermined areas of interest may be defined in any suitable image or scene to be imaged with a limited domain (e.g., a user's face, a user's skin, and/or another suitable background) based on one or more predetermined attributes in the content of the limited domain. For example, a high-complexity region in an image or a scene to be imaged may be determined to be an area of interest and therefore be scaled at a higher scaling value. As illustrative examples, tattoos on a user, skin with fine details, logos on a background (e.g., on a garment, sign, or other background) and/or other high-complexity regions in an image may be determined to be area(s) of interest and may be scaled at high scaling value(s) relative to the rest of the image (or scene to be imaged).

Regardless of the area(s) of interest in an image or a scene to be imaged, the known/predetermined area(s) of interest may be defined using heuristics (e.g., as shown in FIG. 9), tracking one or more features using sensor(s) in the electronic device, and/or using one or more machine learning algorithms. In this way, the area(s) of interest may be defined, and the final image may be scaled/weighted non-uniformly to allow for lower power consumption.

Although FIGS. 1-11 have shown and described displaying a non-uniform scaled or non-uniform weighted image on a three-dimensional display of a head-mounted device, this is merely illustrative. In some embodiments, a non-uniform scaled or non-uniform weighted image may be displayed on a two-dimensional display and/or on a display in a non-head-mounted electronic device, such as a cellular telephone, a wristwatch device, a tablet device, a computer (or laptop computer), and/or any other suitable electronic device.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. An electronic device, comprising:
a housing;
at least one camera coupled to the housing configured to capture an image;
at least one inward-facing display coupled to the housing; and
an outward-facing display coupled to the housing that is configured to display the image with a first region having a first scaling and a second region having a second scaling that is different from the first scaling based on predetermined areas of interest in the image.

2. The electronic device of claim 1, further comprising:
one or more processors configured to scale the first region with the first scaling and the second region with the second scaling, wherein the first scaling and the second scaling are predetermined based on the predetermined areas of interest.

3. The electronic device of claim 2, further comprising:
an additional camera configured to define the predetermined areas of interest based on predetermined attributes in content of the captured image.

4. The electronic device of claim 3, wherein the additional camera comprises a gaze tracker and one of the predetermined areas of interest comprises an eye.

5. The electronic device of claim 2, wherein the camera includes the one or more processors.

6. The electronic device of claim 2, further comprising:
a display pipeline that includes the one or more processors.

7. The electronic device of claim 1, wherein the first region corresponds with a first predetermined area of interest, the first scaling is a first predetermined scaling of at least 30%, the second region corresponds with a second predetermined area of interest surrounding the first predetermined area of interest, and the second scaling is a second predetermined scaling of at least 10%.

8. The electronic device of claim 7, wherein the image further comprises a buffer region between the first and second predetermined areas of interest, the buffer region is scaled to a third predetermined scaling of at least 20%, and the third predetermined scaling is different from the first predetermined scaling and the second predetermined scaling.

9. The electronic device of claim 8, wherein the first predetermined area of interest comprises an eye, and the second predetermined area of interest comprises skin.

10. The electronic device of claim 1, wherein the at least one camera is configured to output the image with the first scaling and the second scaling.

11. The electronic device of claim 1, wherein the camera comprises a two-dimensional camera and the outward-facing display comprises a three-dimensional display.

12. A method of operating a head-mounted device with a display, the method comprising:
generating an image of content with a camera;
scaling a first region of the image with a first predetermined scaling and a second region of the image with a second predetermined scaling that is different from the first predetermined scaling based on predetermined attributes of the content in the image; and
displaying the image with the first and second regions on the display.

13. The method of claim 12, wherein generating the image with the camera comprises generating a two-dimensional image, and wherein displaying the image on the display comprises displaying the image on a three-dimensional display.

14. The method of claim 12, wherein scaling the first region of the image based on the predetermined attributes of the content in the image comprises scaling the first region based on a first predetermined area of interest corresponding to an eye, and wherein scaling the second region based on the predetermined attributes of the content in the image comprises scaling the second region based on a second predetermined area of interest surrounding the first predetermined area of interest corresponding to skin.

15. The method of claim 14, wherein scaling the image further comprises scaling the first region to 30% or more and scaling the second region to 10% or more.

16. The method of claim 12, further comprising:
tracking the predetermined attributes of the content in the image using an additional camera.

17. The method of claim 12, wherein scaling the first region and the second region based on the predetermined attributes of the content in the image comprises scaling the first and second regions using one or more processors in a display pipeline.

18. The method of claim 12, wherein scaling the first region and the second region based on the predetermined attributes of the content in the image comprises scaling the first and second regions using one or more processors in the camera.

19. A method of operating a head-mounted device with an inward-facing display and an outward-facing three-dimensional display, the method comprising:
generating a two-dimensional image comprising a first region with a first predetermined weighting and a second region with a second predetermined weighting that is different from the first predetermined weighting based on one or more predetermined areas of interest using a camera; and
displaying the two-dimensional image on the outward-facing three-dimensional display.

20. The method of claim 19, wherein generating the two-dimensional image comprising the first and second regions with the first and second predetermined weightings comprises determining the one or more predetermined areas of interest and the first and second predetermined weightings using a machine learning model based on one or more predetermined attributes of content in the two-dimensional image.
